(19) United States
(12) Patent Application Publication
(10) Pub. No.: US 2006/0131404 A1
(43) Pub. Date: Jun. 22, 2006

(54) Process for auditing an alcohol beverage inventory

(76) Inventor: Randall Dervishian, Madeira Beach, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/017,591

(22) Filed: Dec. 20, 2004

(51) Int. Cl. G06Q 30/00

(52) U.S. Cl. 235/385

(57) ABSTRACT

Generally, the invention is a system and process that allows the bar owners to inventory the bar in a fraction of the time using conventional methods, and accounting for inventory to the hundredth of an ounce. This precise digital analysis compares the amount of product recorded through the Point Of Sale (POS) system against the amount of product that has actually been used. The data is then transferred into a report that enables owners to see precise losses per bottle as well as other useful information to maximize profits. In its simplest embodiment, the inventive system and process includes a system for scanning and weighing every open bottle, scanning all unopened stock, downloading the POS information, entering invoices and running reports.

### FIELD OF THE INVENTION

The invention relates generally to a system and process for use in taking inventory of alcohol products dispensed in full and partially full bottles or containers.

### BACKGROUND OF THE INVENTION

Inventory control and accountability has been a major concern for all lounges, bars and restaurants. Without some type of control and accurate auditing, the current systems used by the industry is ripe for fraud, theft and over-pouring by bartenders.

Some prior art methods include real-time measuring where equipment is connected to lines run from the bottles through control valves to the pourer at the bar. However, these methods are often inaccurate as they are primarily designed for pour control. In these systems, the lines get clogged or gummy, and customers complain that they did not get an expected poured portion of liquor. Although less liquor is poured, clients are lost due to drinks lacking expected amount of alcohol. Other prior art methods include weighing the product or visually estimating the content level in tenths and manually calculating the inventory. In some cases, computers are used to assist in the calculations with the use of touch screens such as in U.S. Pat. No. 6,616,037 to Grimm et al.

Most bars are losing up to 25% of their liquor inventory and the losses go unnoticed. Losses occur due to incorrectly ringing sales, over-pouring, spillage and theft. These losses are referred to as shrinkage and go unnoticed. The losses take place and continue to go unnoticed due to inadequate methods of analysis, for example, the point system and human error.

The point system relies on estimating volume, typically to the nearest 10th, allowing for a costly margin of error, exaggerated by the different shapes in the bottles. Each point increment of a one-liter bottle contains 10% of the bottle's volume or 3.38 ounces. Ten percent of the liter bottle contains over 2.5 drinks. Eyeing a bottle of liquor from across the bar see an average 10%-20% margin of error (3-5 drinks).

For example, an average size bar with 300 open bottles of liquor might see a miscalculation of inventory by more than 600 drinks using a point-based system. That could represent over $2000.00 in revenue.

Ninety-five percent of bars use the point system. Under the current circumstances, a 25% shrinkage rate can cost the bar owners 32% of their profits. By converting that shrinkage back into sales, the example below demonstrates additional revenue above costs totaling $3,333.00.

For example, assume current conditions is that cost is $2,800.00, profit is $7,200.00 and total sales are therefore $10,000.00. Now assuming that of the $2,800.00, cost is really $2100.00 and shrinkage is $700.00. When the shrinkage is converted to additional sales of $3,333.00, the potential profits are now $10,533.00 with sales totaling $13,333.00. Applying this equation to a bar owner's monthly beverage sales demonstrates that the bar owner can not afford these kinds of losses.

What is needed is a system and process where bar owners can integrate a digital scale and a wireless bar code data collection terminal with an advanced software application to accurately weigh open bottles of liquor, enabling them to control inventory to the last drop.

### SUMMARY OF THE INVENTION

Generally, the invention herein disclosed allows the bar owners to inventory the bar in a fraction of the time using conventional methods, accounting for inventory to the hundredth of an ounce. This precise digital analysis compares the amount of product recorded through the Point Of Sale (POS) system against the amount of product that has actually been used. The data is then transferred into a report that enables owners to see precise losses per bottle as well as other useful information to maximize profits.

In its simplest embodiment, the inventive system and process includes a system for scanning and weighing every open bottle, scanning all unopened stock, downloading the POS information, entering invoices and running reports.

Generally, the invention applies to all forms of beverages, typically, beer, wine, champagne and alcohol such as vodka, whiskey, rum, scotch, liqueurs, etc. Alcohol in this disclosure will be used to generically refer to such wines, champagne, beers, alcohol, liqueurs, etc.

### BRIEF DESCRIPTION OF THE DRAWINGS

In the accompanying drawings:

FIG. 1 is a conceptual representation of one embodiment of the inventive system and process;

FIG. 2 is a conceptual representation depicting the bar code of the bottle being scanned using a scan gun module;

FIG. 3 is a depiction of a partially filled bottle with examples of visual incremental volumes in tenths to depict one of the conventional methods of obtaining inventory levels of liquor;

FIG. 4 is a schematic flow chart depicting the steps of the inventive process;

FIG. 5 depicts an example of a computer screen depicting on-hand inventory data for beer obtained from scanning the inventory using the inventive process;

FIG. 6a depicts an example of a computer screen depicting an example of a report for a beer and a liquor generated from the computer software; and

FIG. 6b depicts another example of a computer screen showing a generated report in a different format than FIG. 6a showing as an example a brand of beer and a brand of vodka alcohol.

### DETAILED DESCRIPTION OF THE INVENTION

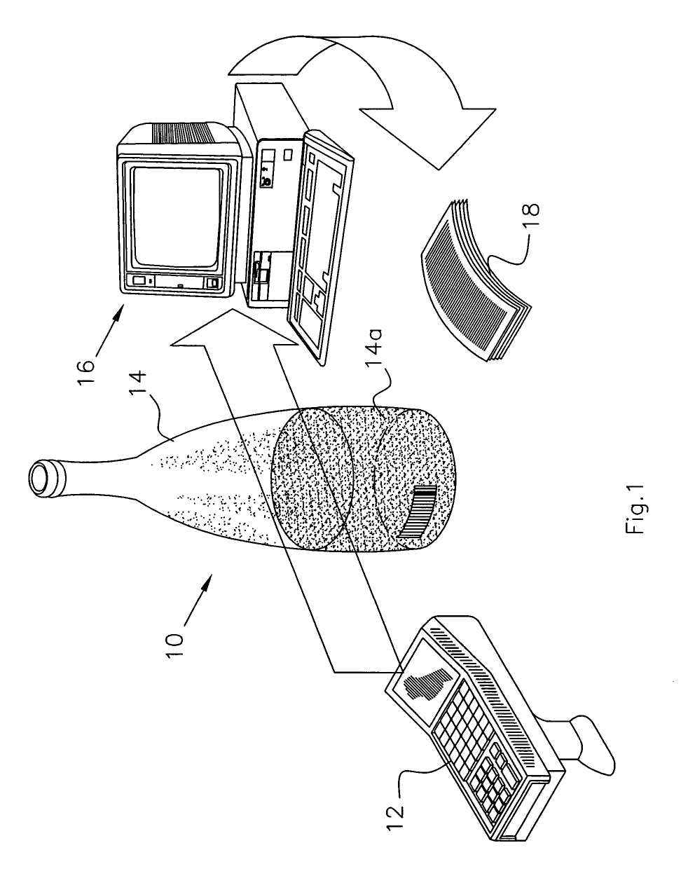

Referring now to the drawings, FIGS. 1-4 disclose various embodiments of the present invention, which is a process for auditing an alcohol beverage inventory, depicted generally as 10.

FIG. 1 is a conceptual representation of one embodiment of the inventive system and process, wherein a scan gun module 12 scans an opened container 14 of a beverage 14a, typically alcohol, beer, wine, and any alcohol containing product, and data is representationally transferred to a computer 16 for processing. The computer 16 includes software to synchronize the data inputted and for making desired analyses so that useful and accurate inventory and costs related reports 18 can be generated. Given inputted parameters and desired output data in reports, a programmer skilled in the art can write the source code/software for loading on a computer and in the scan gun module processor circuitry.

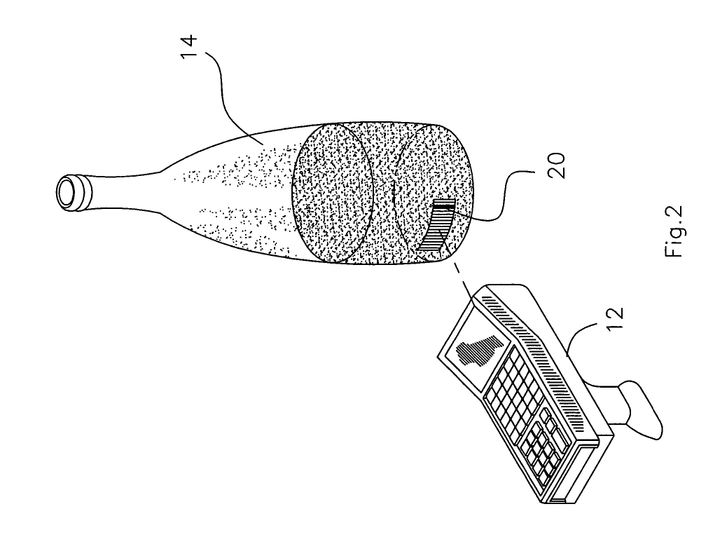

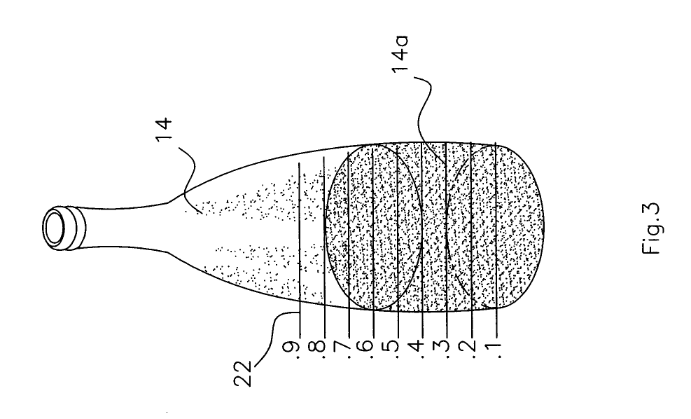

FIG. 2 is a conceptual representation depicting the bar code 20 of the bottle container 14 being scanned using a scan gun module 12 to identify the specific container of alcohol being inventoried. FIG. 3 is a depiction of a partially filled bottle 14 with examples of visual incremental volumes in tenths as shown by the incremental lines 22 to depict one of the conventional methods of obtaining inventory levels of liquor. It is anticipated that this conventional method of visualizing the content 14a level to estimate remaining volume of liquor 14a in the container 14 can also be utilized as an adjunct step within the scope of the present inventive process. In the example of FIG. 3, a bar owner would estimate that there are 0.4 tenths of liquor 14a remaining in the bottle 14.

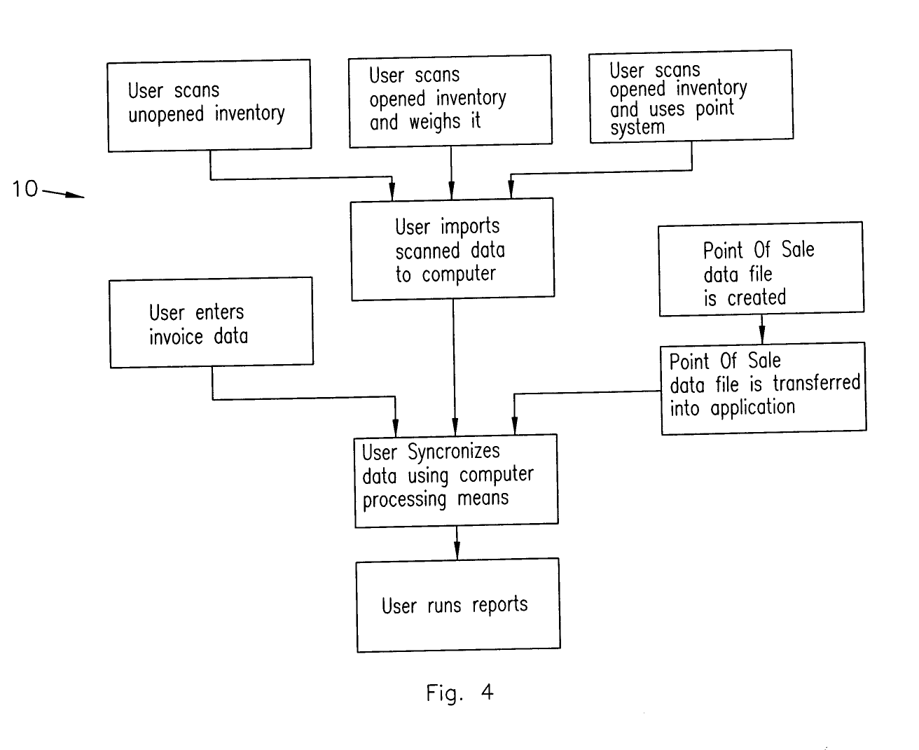

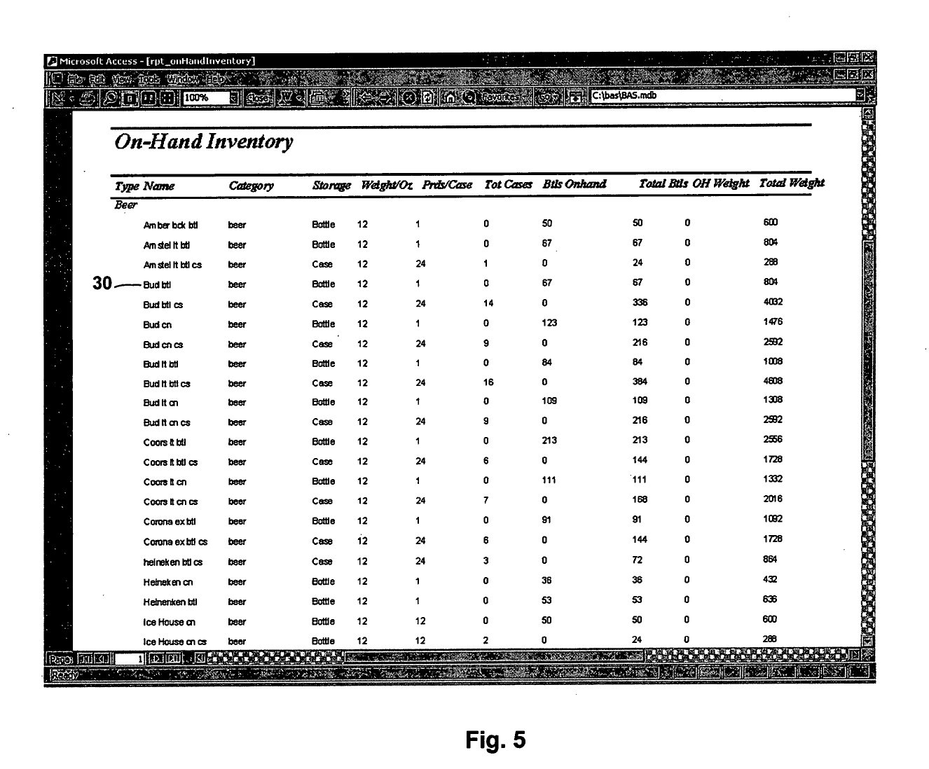

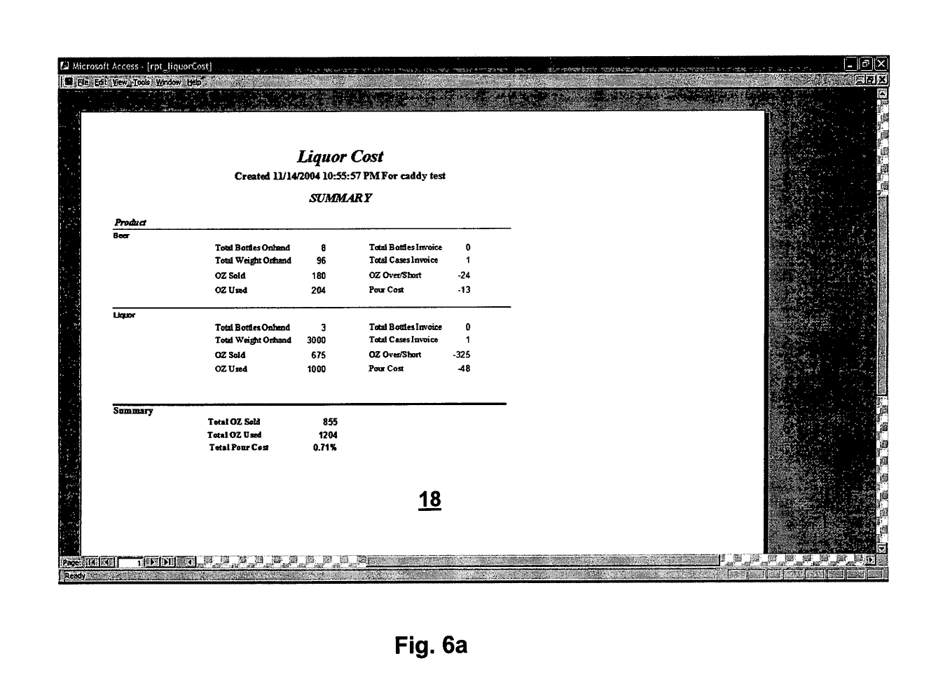

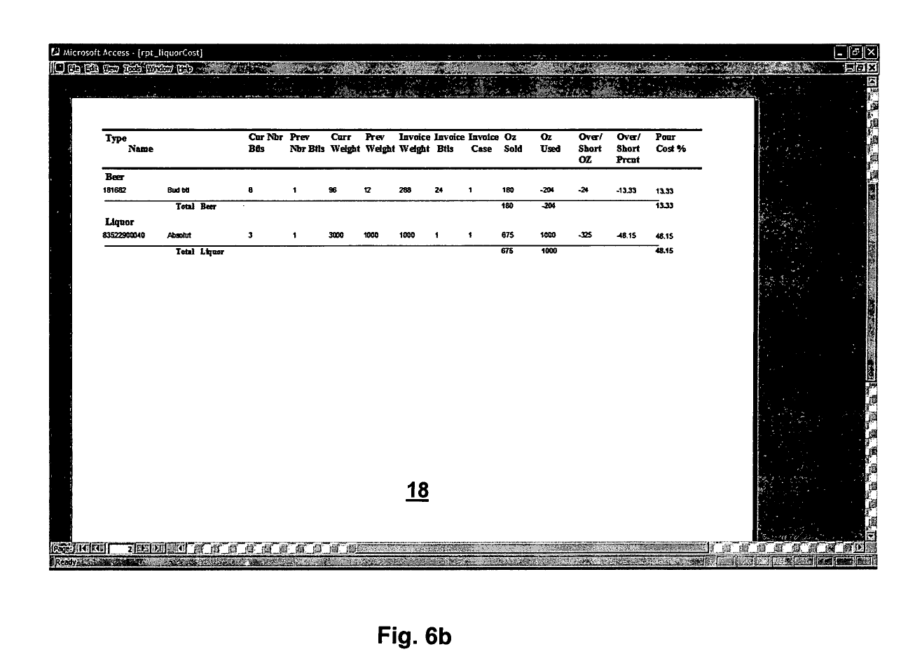

As mentioned above, FIG. 4 is a schematic flow chart depicting examples of the steps of the inventive process. FIG. 5 depicts an example of a computer screen depicting on-hand inventory data for beer obtained from scanning the inventory using the inventive process. An on-hand inventory of alcohol such as vodkas and the like are not shown but by example, would be similar in nature. FIGS. 6a and 6b are screen shorts depicting examples of reports generated from the computer software. The columns or data shown are only examples of the tyupe of information that could be generated in the reports.

Any kind of alcoholic beverage, whether beer, wine, champagne, liqueurs, traditional alcohol beverages such as vodka and whiskey and the like, will be generically referred to herein and in the claims as “alcohol” or “alcohol content” or “alcohol product.” Further, it makes no difference whether the alcohol container is a bottle in the traditional sense, a boxed container such as boxed wine products, or a keg of beer. It is anticipated that any commercial container of an alcohol product can be inventoried and audited regardless of the container design.

Now referring again to FIG. 4 for an flow chart understanding of the process, one of the steps of the process has the user scanning the UPC bar code number 20 on the item (bottle 14), in this case, unopened containers. The scan gun module 12 displays the item name identified by pre-programming the scan gun microprocessor. The user then enters the number of items. For example, if there are 5 bottles of Jack Daniels, the user scans the UPC bar code and then enters the quantity 5.

For opened containers, that is, partially used containers, the user puts the item on a scale to weigh the container 14, scans UPC bar code number 20 on item 14, the scan gun 12 displays the item name as above, and the user enters the weight displayed on the scale. For example, if a bottle of Jack Daniels weighs 900 grams, the user scans UPC bar code and then enters 900. The software is pre-programmed with the empty weight data for the container so that the program can calculate the actual inventory of alcohol product 14a remaining in the container 14.

As an adjunct step to the process, a bar owner optionally has the ability to incorporate visually obtained inventory data using the point system of tenths of volume remaining in the container 14 (see FIG. 3). In this case, the user scans the UPC bar code number 20 on the item container 14. The scan gun 12 displays the item name, and the user enters the number of points of item product remaining in the container by visually estimating the level 22. For example, if bottle of Jack Daniels is half full, the user scans UPC bar code 20 and then enters a 0.5 as the remaining inventory in the container 14.

The user then opens the application, using computer-processing means with appropriate software to analyze the imported data 30 and to generate reports 18. The user can import the data by connecting the scan gun 12 to a computer (PC) 16 via a serial cable. The user would then navigate to “download inventory from scan gun” in the application, and then to navigate to “download inventory to the PC” on scan gun 12. A separate third party software program or a customized software program is launched that takes the data from the scan gun and exports it into the application on the PC 16.

In another step, the user navigates to the “Input Invoices” section in the software application and manually inputs number of items received. These invoices are usually provided by vendors when they deliver liquor products 14a. Inventory purchase costs is also typically available from these invoices and this data can be imported into the application software.

In another step, the user uses their Point of Sales (POS) system such as Micros and uses that system's extract functionality to create a file that contains all the POS information for a specific period of time. This file can be saved to a disk if the POS system computer and the application software of the present invention is not on the same computer 16.

The user navigates to the “Import POS data” functionality in the application software and that in turn runs a process that makes the data available to the application. Note: If the POS system and application software for the present invention are on two separate computers 16, a disk containing the POS data is inserted in the computer running the application software.

The user navigates to the “Synchronize” functionality in the application software. This takes all the different feeds and does the following: moves last inventory data 30 into history data tables; and transfers current data 30 into the appropriate inventory data tables.

The user runs reports 18 that show last and current inventory 30, and costs. Costs are calculated by taking last weeks inventory (or any desired period such as quarterly), add all invoice information, subtracting POS data, and comparing that result to current inventory.

Referring back to FIG. 5, the example depicts an on-hand inventory screen, where inventory data 30 is presented. Although several desirable parameters can be stored or entered in the application software, the example given shows types/brands of beer, container form (case, bottle, etc.), weight by ounces per unit, number of products/case, total cases, bottles on-hand, etc. Similarly, other useful types of information are provided by example in FIG. 5b for non-beer products.

FIGS. 6a and 6b are examples of the types of useful information that can generated on a report 18. This information would be generated by the means for processing the data inputted, that is, by the computer, the scan gun module processor and the application software loaded into the equipment. In the example, among the parameters shown are the current number of items, the previous number of items, the current weight, the previous weight, the invoice weight, invoice data related to bottles and cases or any other container type, the amount sold in ounces per item, the amount used in ounces per item, the over/short amount in ounces for the item, and over/short percent for the item and the pour cost for the item. Given this type of data, not only can the owner evaluate its costs, he can analyze the losses and financial impact and provide for a systemic resolution to generate higher profits by addressing waste in loss areas of the bar business.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

1. A system for auditing an alcohol beverage inventory comprising:
means for scanning a barcode of opened containers having an alcohol product therein, said barcode further serving as means for identifying the alcohol product contained within each of said scanned barcoded opened container;
means for scanning a barcode of unopened containers having an alcohol product therein, said barcode further serving as means for identifying the alcohol product contained within each of said scanned barcoded unopened container;
said means for scanning the barcode of the unopened containers further having means for determining a volume of the product in each unopened container;
means for weighing the opened containers, said means for weighing the opened containers further having means for determining a volume of the product remaining in each opened container;
data processing means for processing data associated with the scanning means and weighing means, for receiving point of sales data related to the product, for receiving cost data from purchase invoices for the product, for synchronizing said combination of data to produce a report related to the inventory of the product and its associated financial data;
means for downloading inventory data generated from the scanning and weighing means to the data processing means; and
means for generating a report comprising inventory related data and financial related data for each product.

2. The system according to claim 1, further comprising means for inputting the point of sales data and the cost data from purchase invoices for the product to the data processing means.

3. The system according to claim 1, further comprising means for inputting to the data processing means, a remaining volume of an opened container,
wherein the remaining volume is obtained from a visual observation of the product in the container.

4. The system according to claim 3, wherein the remaining volume is expressed as a percentage of the product originally included in the container.

5. The system according to claim 2, wherein the generated report further comprises cost and profit related financial data and inventory loss data.

6. A method of auditing an alcohol beverage inventory comprising:
providing a system wherein
barcodes of opened containers having an alcohol product therein are scanned, said barcode further serving as means for identifying the alcohol product contained within each of said scanned barcoded opened container;
barcodes of unopened containers having an alcohol product therein are scanned, said barcode further serving as means for identifying the alcohol product contained within each of said scanned barcoded unopened container, wherein a volume of the product in each unopened container is determined from the scanning process;
weighing the opened containers, wherein a volume of the product remaining in each opened container is determined;
using data processing means, processing data associated with the scanning and weighing processes, receiving point of sales data related to the product, receiving cost data from purchase invoices for the product, and synchronizing said combination of data to produce a report related to the inventory of the product and its associated financial data;
downloading inventory data generated from the scanning and weighing processes to the data processing means; and
generating a report comprising inventory related data and financial related data for each product.

7. The method according to claim 6, further comprising inputting the point of sales data and the cost data from purchase invoices for the product to the data processing means.

8. The method according to claim 6, further comprising inputting to the data processing means, a remaining volume of an opened container,
wherein the remaining volume is obtained from a visual observation of the product in the container.

9. The method according to claim 8, wherein the remaining volume is expressed as a percentage of the product originally included in the container.

10. The method according to claim 7, wherein the generated report further comprises cost and profit related financial data and inventory loss data.

11. A system for auditing an alcohol beverage inventory comprising:
means for scanning a barcode of opened containers having an alcohol product therein, said barcode further serving as means for identifying the alcohol product contained within each of said scanned barcoded opened container;
means for scanning a barcode of unopened containers having an alcohol product therein, said barcode further serving as means for identifying the alcohol product contained within each of said scanned barcoded unopened container;
said means for scanning the barcode of the unopened containers further having means for determining a volume of the product in each unopened container;
means for inputting to a data processing means a remaining volume of an opened container, wherein the remaining volume is obtained from a visual observation of the product in the container;
the data processing means being for processing data associated with the scanning means and the remaining volume visually observed, the data processing means further being for receiving point of sales data related to the product, for receiving cost data from purchase invoices for the product, for synchronizing said combination of data to produce a report related to the inventory of the product and its associated financial data;
means for downloading inventory data generated from the scanning means and means for inputting the remaining volume of the opened container to the data processing means; and
means for generating a report comprising inventory related data and financial related data for each product.

12. The system according to claim 11, further comprising means for inputting the point of sales data and the cost data from purchase invoices for the product to the data processing means.

13. The system according to claim 11, further comprising means for weighing the opened containers, said means for weighing the opened containers further having means for determining a volume of the product remaining in each opened container.

14. The system according to claim 11, wherein the remaining volume is expressed as a percentage of the product originally included in the container.

15. The system according to claim 12, wherein the generated report further comprises cost and profit related financial data and inventory loss data.

16. A method of auditing an alcohol beverage inventory comprising:
providing a system wherein
barcodes of opened containers having an alcohol product therein are scanned, said barcode further serving as means for identifying the alcohol product contained within each of said scanned barcoded opened container;
barcodes of unopened containers having an alcohol product therein are scanned, said barcode further serving as means for identifying the alcohol product contained within each of said scanned barcoded unopened container, wherein a volume of the product in each unopened container is determined from the scanning process;
inputting to a data processing means a remaining volume of an opened container, wherein the remaining volume is obtained from a visual observation of the product in the container;
using the data processing means and processing data associated with the scanning and visual observation processes, receiving point of sales data related to the product, receiving cost data from purchase invoices for the product, and synchronizing said combination of data to produce a report related to the inventory of the product and its associated financial data;
downloading inventory data generated from the scanning and weighing processes to the data processing means; and
generating a report comprising inventory related data and financial related data for each product.

17. The method according to claim 16, further comprising inputting the point of sales data and the cost data from purchase invoices for the product to the data processing means.

18. The method according to claim 16, further comprising weighing the opened containers, wherein a volume of the product remaining in each opened container is determined.

19. The method according to claim 16, wherein the remaining volume is expressed as a percentage of the product originally included in the container.

20. The method according to claim 17, wherein the generated report further comprises cost and profit related financial data and inventory loss data.
